(19) United States
(12) Patent Application Publication
(10) Pub. No.: US 2014/0122620 A1
(43) Pub. Date: May 1, 2014

(54) ATTACHMENT HANDLING DURING EMAIL DELIVERY

(71) Applicant: Google Inc., (US)

(72) Inventors: Liang LIN, Mountain View, CA (US); Jaishankar SUNDARARAMAN, Mountain View, CA (US); Balaji RAGHAVAN, Mountain View, CA (US); Wiltse CARPENTER, San Francisco, CA (US); John BUCY, San Francisco, CA (US); Ram Kumar RENGASWAMY, New York, NY (US)

(73) Assignee: GOOGLE INC., Mountain View, CA (US)

(21) Appl. No.: 13/662,153

(22) Filed: Oct. 26, 2012

(51) Int. Cl. G06F 15/16

(52) U.S. Cl. 709/206

(57) ABSTRACT

A system and method for improving attachment handling during email delivery is disclosed. A partial message data structure stores data associated with an email except the email's attachments' contents. Attachment contents may be stored in the partial message data structure if necessary. When an email is sent to a recipient, a message router constructs the full email message including attachments from the partial message data structure and the stored attachment contents before sending the email to an SMTP server. When an email is received from an SMTP server, a message router transmits the email to a message parser that parses attachments from the email and stores the attachments in persistent storage. The message parser sends a partial message data structure containing data associated with the email and references to the email's attachments to the message router. The message router transmits the partial message data structure to a server for delivery.

### BACKGROUND

Electronic mail, or email, is a powerful communication tool that allows information to be exchanged nearly instantaneously. There are several email client applications that allow users to draft email messages through a user interface and send the messages to recipients. Some email messages may contain files as attachments that are delivered to a recipient along with the message. An email attachment may be any file type including a spreadsheet, a word processing document, or a photograph. One or more files can be attached to a given email message. Attachments can vary in size, typically ranging from a few bytes to twenty-five megabytes.

In a conventional system, data structures called full message data structures are created to organize, store, and manipulate email messages and their attachments. Typically, these data structures are in Multipurpose Internet Mail Extensions (MIME) format and are flat byte strings. Full message data structures include all information regarding an email including sender, recipient, and subject. These data structures also include all content of associated attachments as well as the attachments' metadata. Full message data structures can include information regarding the sender, the recipient, the message, MIME-Version, Content-ID, Content-Type, Content-Disposition, Content-Transfer-Encoding, and Encoded-Word. The Full message data structure may contain information per attachment including: Content-Type, Content-Transfer_Encoding, Content-ID (used for displaying an attachment in-line such as an advertisement or a picture), Content-Disposition, and the actual content of the attachment. A full message data structure representing an email is transmitted internally anytime the email and/or its attachments are modified or when the email is sent to a recipient. FIG. 1 illustrates an example of a full message data structure containing two image attachments (111a,b).

When a user clicks a send button, or initiates a send action in some other manner in an email client application, the email's full message data structure is routed through the sender's email client application's servers (202a), referred to as internal mail servers, to Simple Mail Transfer Protocol (SMTP) servers (204), and then to servers controlled by the email recipient's email client application (202b) as shown in FIG. 2.

For example, a user (200a) using an email client application may want to send a message to a recipient who uses a different email client application (200b) for email. The sender may draft an email. Once an email has been drafted and the appropriate attachments attached, a user may click send, starting the process of routing the email to the recipient's email client's application servers. As discussed above, emails are typically relayed from an email client to a mail server via SMTP in MIME format.

In a conventional system, the full message data structure is transmitted internally in an email client application anytime there are changes to the email or when an email is transmitted to a recipient. The full message data structure size makes routing slower since sending a data structure which contains all information including attachment contents increases the latency of transmission. However, it is not always necessary to transmit or route the full message structure. Most internal manipulation of email messages does not require actual email attachment content information. When a user interacts with an email client application, the user often performs operations which merely require the subject and body of an email and do not require loading attachments. For example, users may read through old messages or forward an email to a friend. Attachments do not need to be loaded from a server in order to accomplish these tasks. Since the attachments are not necessary, there is no need to load attachments into the server especially when the server is serving a lot of users. Therefore, there should be a way to improve attachment handling so that emails can be routed to SMTP servers and delivered to email client application servers with reduced latency. Routing emails without their associated attachments also requires less network bandwidth since huge email data structures will not be sent across the network. Additionally, since attachments are often large, not storing these attachments in memory frees up the memory for other uses. Finally, less CPU time is required to process emails without their large attachments.

### SUMMARY

This specification describes technologies relating to email attachment handling in general, and specifically to methods and systems for improving attachment handling during email delivery and receipt.

In general, one aspect of the subject matter described in this specification can be embodied in a system and method for improving email attachment sending flow. An exemplary system includes: one or more processing devices and one or more storage devices storing instructions that, when executed by the one or more processing devices, cause the one or more processing devices to: receive a partial message data structure for an email with an associated attachment; retrieve the associated email attachment contents from persistent storage using an attachment reference; construct a full message data structure from the email's partial message data structure and the retrieved email attachment contents; and transmit the full message data structure to an SMTP server to be routed to a recipient. An exemplary method includes: receiving a partial message data structure for an email with an associated attachment; retrieving the associated email attachment contents from persistent storage using an attachment reference; constructing a full message data structure from the email's partial message data structure and the retrieved email attachment contents; and transmitting the full message data structure to an SMTP server to be routed to a recipient. Another aspect of the subject matter described in this specification can be embodied in a system and method for improving email attachment handling delivery. An exemplary method includes: receiving an email message that contains an attachment; transmitting the email to a message parser which parses the attachment from the email and stores the attachment in persistent storage; receiving a partial message data structure from the message parser which includes email data and a reference to the attachment; and transmitting the partial message data structure to a server for delivery.

These and other embodiments can optionally include one or more of the following features: (1) an attachment reference may be obtained from the partial message data structure; (2) the attachment reference may be obtained from client cache; (3) the partial message may be stored in Protocol Buffer format; (4) the partial message may be stored in XML format; and (5) the partial message may be stored as an object in a programming language.

The details of one or more embodiments of the invention are set forth in the accompanying drawings which are given by way of illustration only, and the description below. Other features, aspects, and advantages of the invention will become apparent from the description, the drawings, and the claims. Like reference numbers and designations in the various drawings indicate like elements.

### BRIEF DESCRIPTION OF THE DRAWINGS

FIG. 1 is a block diagram illustrating a full message data structure.

FIG. 2 is a block diagram illustrating a conventional email delivery path.

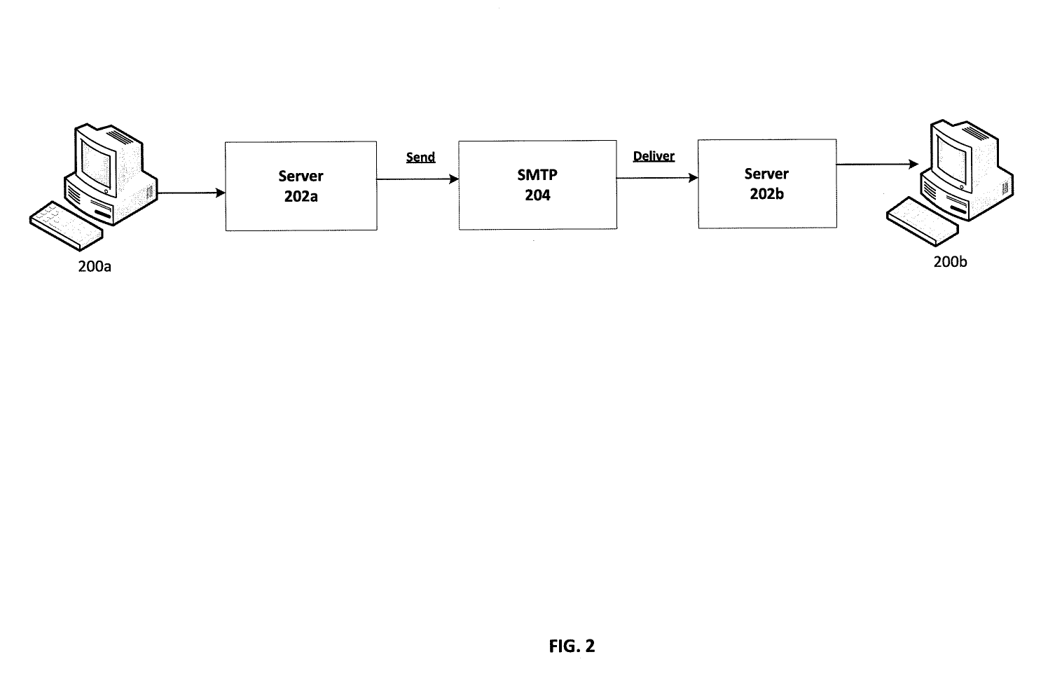

FIG. 3 is a block diagram illustrating a partial message data structure for the same email that is represented by a full message data structure in FIG. 1.

FIG. 4 is a flow diagram of an exemplary method for improving email attachment sending flow.

FIG. 5 is a block diagram illustrating an exemplary email delivery path.

FIG. 6 is a flow diagram of an exemplary method for improving email attachment handling delivery.

FIG. 7 is a block diagram illustrating an exemplary email delivery system.

FIG. 8 is a block diagram illustrating an exemplary computing device.

### DETAILED DESCRIPTION

Attachment contents often do not need to be transmitted through an email client application system until the email with which the attachment is associated is transmitted to a recipient. According to an exemplary embodiment, a data structure may be used to send details about email messages and their attachments throughout an email client application system without sending actual attachment contents until messages are ready to be sent to the SMTP server for delivery. This data structure is called a partial message data structure and may be created and stored as serialized structured data such as a protocol buffer. Protocol buffers are automated mechanisms for serializing structured data. Partial message data structures may also be in XML format. Additionally, partial message data structures may be stored as objects in programming languages such as Java, C++, or Python. Since the partial message data structure may include a reference to attachment contents instead of the attachment contents themselves and may therefore not be as large as a full message data structure, an email represented by a partial message data structure is more efficient for processing than the same email represented by a full message data structure.

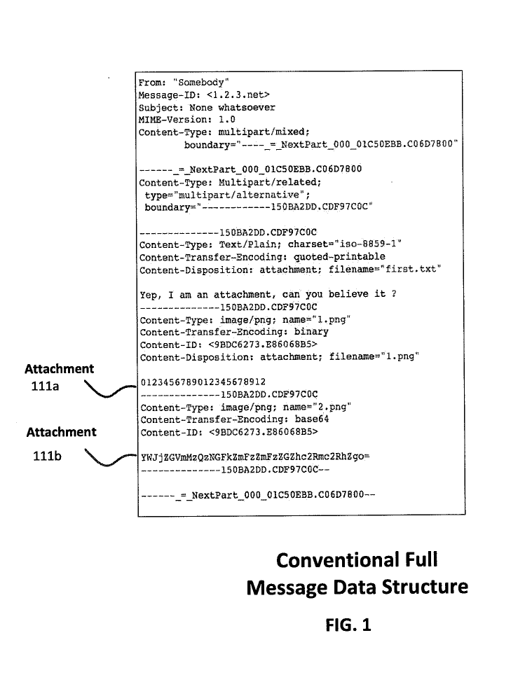

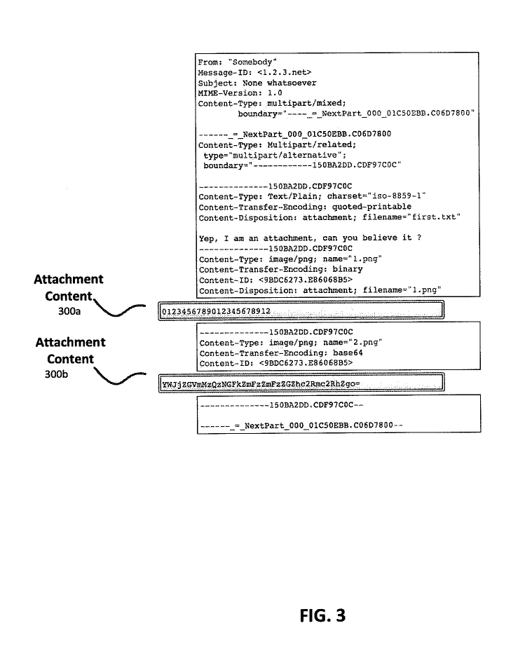

In an exemplary embodiment when an email is created, a partial message data structure may be constructed to represent the email. This partial message data structure may organize and store all parts of an email except the contents of any associated attachments. Although a partial message data structure may store attachment contents if necessary, the data structure may contain only references to attachment contents. Instead of storing attachments in the partial data structure, attachment contents may be stored in remote persistent storage. FIG. 3 represents a partial message data structure for the same email that was represented by a full message data structure in FIG. 1. In FIG. 3, 300a and 300b are attachment contents that are stored in remote persistent storage.

In some embodiments, a partial message data structure may be transmitted internally in an email client application anytime there are changes to the email or when an email is transmitted to a recipient. A partial message data structure's size makes routing an email faster than routing the same email represented by a full message data structure since a data structure which does not include attachment contents is smaller than a data structure that does contain attachment contents.

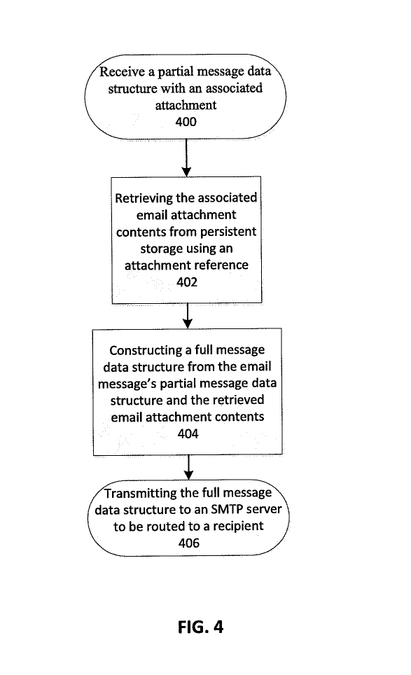

When a user clicks a send button, or initiates a send action in some other manner in an email client application, the email's partial message data structure is routed through the sender's email client application's servers. However, according to an exemplary embodiment, before being sent to a SMTP server, the partial message data structure is sent to an additional server or component that routes internal emails called a “message router.” An exemplary method, as depicted by FIG. 4, begins with the message router (504) receiving a partial message data structure for an email with an associated attachment (400). The message router retrieves the associated email attachment contents from persistent storage using attachment references (402). References to attachments may be stored in the partial message data structure or in the client cache. When a user uploads attachments from an email client application user interface, the attachments may be sent to a storage system with their references returned to the client cache. If attachments are forwarded or autosaved, the attachments may already be in the remote persistent storage and their references may be stored in the partial message data structure of the attachments' corresponding email.

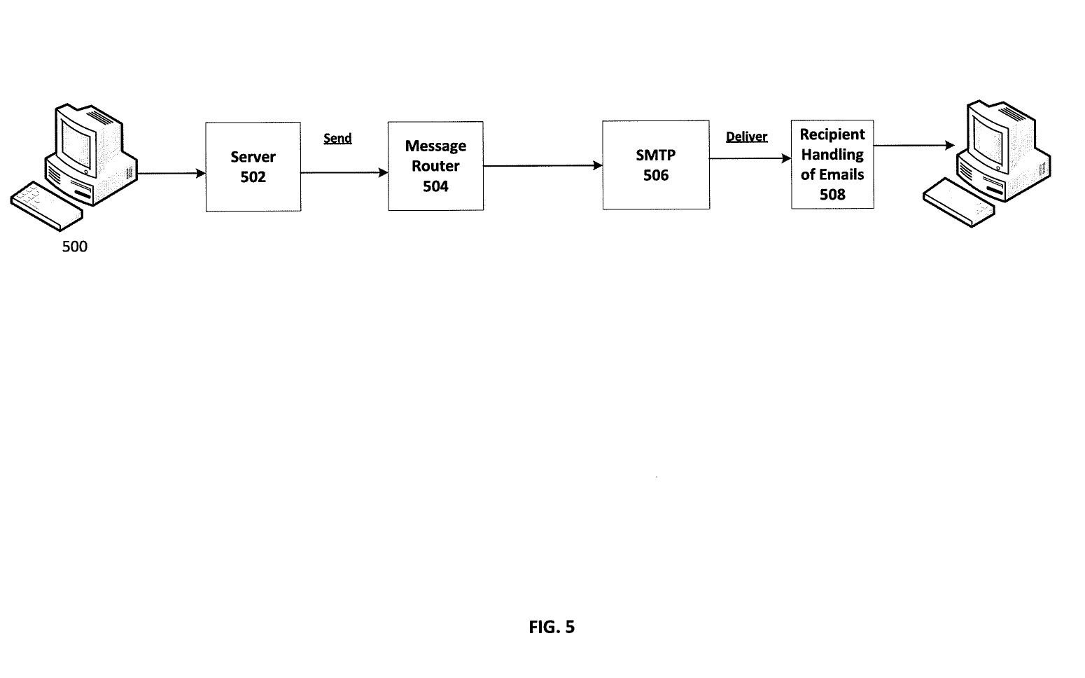

When a full message data structure needs to be constructed, attachments may be retrieved by the message router from remote persistent storage or the server cache, depending on where they are currently stored. The message router then constructs a full message data structure from the partial message data structure and the references to associated attachments which the partial message data structure may contain (404). The email's full message data structure may then be sent to Simple Mail Transfer Protocol (SMTP) servers, and to servers controlled by the email recipient's email client application as shown in FIG. 5 (406).

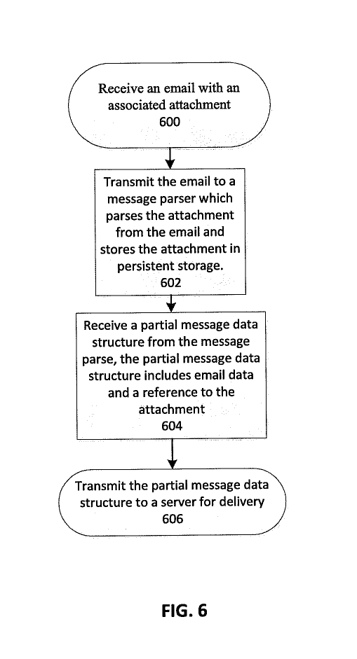

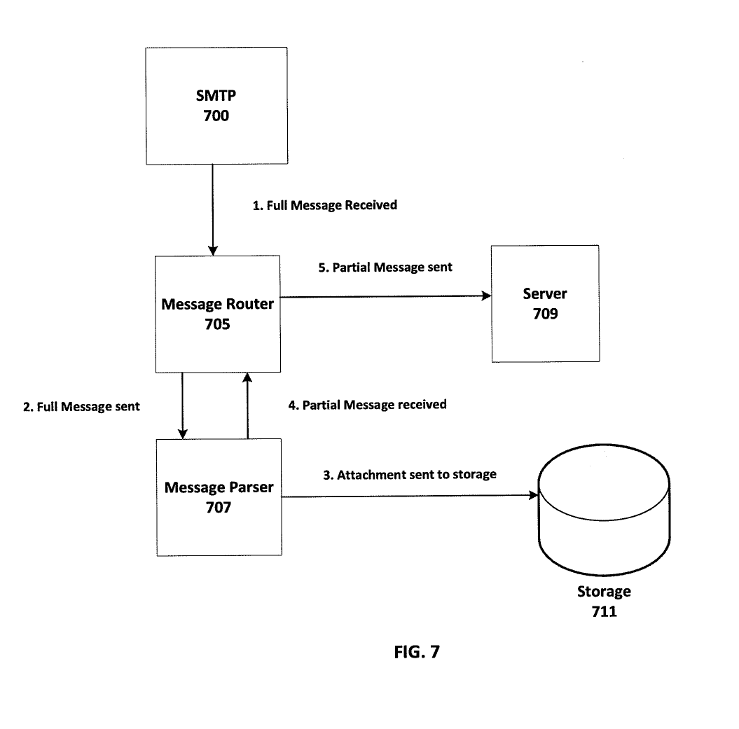

In an exemplary system, not only is data flow and transmission of attachments improved by use of partial message data structures, but email delivery is improved as well. An exemplary embodiment receives an email with an associated attachment from an SMTP server via a message router as shown in FIG. 6. When a message router (705) receives an email from an SMTP server, the message router (705) routes the email to a message parser (707) (600, 602). In the message parser (707), a partial message data structure may be created from the email by removing any associated attachments from the email (602). The attachments may be sent to persistent storage (711) with references to the attachments being returned and stored in the persistent message data structure. The partial message data structure may then be transmitted back to the message router which then routes the data structure to other servers (709) for delivery as shown in FIG. 7 (606).

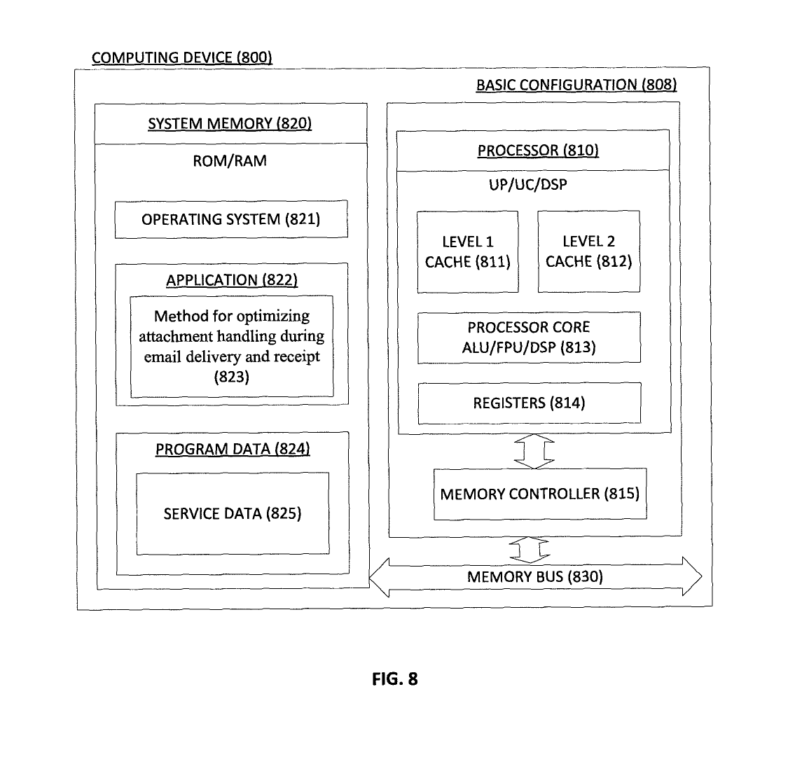

FIG. 8 is a block diagram illustrating an example computing device (800) that is arranged for improving attachment handling during email delivery and receipt. In a very basic configuration (801), the computing device (800) typically includes one or more processors (810) and system memory (820). A memory bus (830) can be used for communicating between the processor (810) and the system memory (820).

Depending on the desired configuration, the processor (810) can be of any type including but not limited to a microprocessor (μP), a microcontroller (μC), a digital signal processor (DSP), or any combination thereof. The processor (810) can include one more levels of caching, such as a level one cache (811) and a level two cache (812), a processor core (813), and registers (814). The processor core (813) can include an arithmetic logic unit (ALU), a floating point unit (FPU), a digital signal processing core (DSP Core), or any combination thereof. A memory controller (816) can also be used with the processor (810), or in some implementations the memory controller (815) can be an internal part of the processor (810).

Depending on the desired configuration, the system memory (820) can be of any type including but not limited to volatile memory (such as RAM), non-volatile memory (such as ROM, flash memory, etc.) or any combination thereof. System memory (820) typically includes an operating system (821), one or more applications (822), and program data (824). The application (822) may include a method for improving attachment handling. Program Data (824) includes storing instructions that, when executed by the one or more processing devices, implement a system and method for improving attachment handling during email delivery and receipt. (823). In some embodiments, the application (822) can be arranged to operate with program data (824) on an operating system (821).

The computing device (800) can have additional features or functionality, and additional interfaces to facilitate communications between the basic configuration (801) and any required devices and interfaces.

System memory (820) is an example of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer storage media can be part of the device (800).

The computing device (800) can be implemented as a portion of a small-form factor portable (or mobile) electronic device such as a cell phone, a personal data assistant (PDA), a personal media player device, a wireless web-watch device, a personal headset device, an application-specific device, or a hybrid device that include any of the above functions. The computing device (800) can also be implemented as a personal computer including both laptop computer and non-laptop computer configurations.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of non-transitory signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium. (e.g., a fiber optic cable, a waveguide, a wired communications link, a wireless communication link, etc.)

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for improving email attachment sending flow comprising:
receiving a partial message data structure for an email with an associated attachment;
retrieving the associated email attachment contents from persistent storage using an attachment reference;
constructing a full message data structure from the email's partial message data structure and the retrieved email attachment contents; and
transmitting the full message data structure to an SMTP server to be routed to a recipient.

2. The method of claim 1, wherein an attachment reference is obtained from the partial message data structure.

3. The method of claim 1, wherein the attachment reference is obtained from the client cache.

4. The method of claim 1, wherein the partial message is stored in Protocol Buffer format.

5. The method of claim 1, wherein the partial message is stored in XML format.

6. The method of claim 1, wherein the partial message is stored as an object in a programming language.

7. A computer-implemented method for improving email attachment handling delivery comprising:
receiving an email message that contains an attachment;
transmitting the email to a message parser which parses the attachment from the email and stores the attachment in persistent storage;
receiving a partial message data structure from the message parser which includes email data and a reference to the attachment; and
transmitting the partial message data structure to a server for delivery.

8. The method of claim 7, wherein an attachment reference is obtained from the partial message data structure.

9. The method of claim 7, wherein the attachment reference is obtained from the client cache.

10. The method of claim 7, wherein the partial message is stored in Protocol Buffer format.

11. A system for improving email attachment sending flow, the system comprising:
one or more processing devices; and
one or more storage devices storing instructions that, when executed by the one or more processing devices, cause the one or more processing devices to:
receive a partial message data structure for an email with an associated attachment;
retrieve the associated email attachment contents from persistent storage using an attachment reference;
construct a full message data structure from the email's partial message data structure and the retrieved email attachment contents; and
transmit the full message data structure to an SMTP server to be routed to a recipient.

12. The system of claim 11, wherein an attachment reference is obtained from the partial message data structure.

13. The system of claim 11, wherein the attachment reference is obtained from the client cache.

14. The system of claim 11, wherein the partial message is stored in Protocol Buffer format.

15. The system of claim 11, wherein the partial message is stored in XML format.

16. The system of claim 11, wherein the partial message is stored as an object in a programming language.

17. A non-transitory computer readable medium having stored therein computer executable code that causes one or more processors to execute the steps of:
receiving a partial message data structure for an email with an associated attachment;
retrieving the associated email attachment contents from persistent storage using an attachment reference;
constructing a full message data structure from the email's partial message data structure and the retrieved attachment contents;
transmitting the full message data structure to an SMTP server to be routed to a recipient.

18. The non-transitory medium of claim 17, wherein an attachment reference is obtained from the partial message data structure.

19. The non-transitory medium of claim 17, wherein the attachment reference is obtained from the client cache.

20. The non-transitory medium of claim 17, wherein the partial message is stored in Protocol Buffer format.
